(19) United States
(12) Patent Application Publication
(10) Pub. No.: US 2018/0129353 A1
(43) Pub. Date: May 10, 2018

(54) INPUT DEVICE, USER EQUIPMENT AND METHOD FOR DETERMINING MOVEMENT

(71) Applicant: HUAWEI TECHNOLOGIES CO., LTD., Shenzhen (CN)

(72) Inventor: Masahide INOUE, Tokyo (JP)

(21) Appl. No.: 15/579,213

(22) PCT Filed: Jun. 4, 2015
(86) PCT No.: PCT/CN2015/080756

§ 371 Date: Dec. 3, 2017

(51) Int. Cl. G06F 3/042; G06F 3/041

(52) U.S. Cl. CPC G06F 3/0421; G06F 2203/04108; G06F 3/0416; G06F 3/0428

(57) ABSTRACT

The present invention provides an input device, a user equipment and a method for determining a movement. The input device includes: an AMFPD substrate; a light source, arranged in the AMFPD substrate; a plurality of photo sensors, arranged in the substrate, wherein each of the plurality of sensors is configured to detect a light ray of the light source reflected by an object over the AMFPD substrate and output a signal which is transformed from the light ray; a controller, connected to the plurality of sensors and configured to determine a movement of the object according to signals output from the plurality of photo sensors. This solution can determine a movement of 2D or 3D dimension of an object moving over the input device.

### FIELD OF INVENTION

The embodiments of the present invention relate to an electronic device, and particularly, to an input device, a user equipment and a method for determining a movement.

### BACKGROUND OF THE INVENTION

A handheld device, like a smart phone, requires an input device for detecting a human gesture at a near field (less than few 10 cm). The input device may be implemented by a proximity sensing technology, a capacitive touch technology, or a camera recognition technology. The capacitive touch technology has less sensitivity, and is available for very near field (i.e. <20 mm). The camera recognition technology has a difficult for near field due to a focus range and requirements for higher power for continuous operation and complex post image processing. The proximity sensing technology is able to detect the presence of nearby object without any physical contact.

In the proximity sensing technology, a proximity sensor unit has been provided to implement the presence of nearby object. The proximity sensor unit includes a single Infrared (IR) Light source or multiple IRs and one IR Photo sensor, for example, the proximity sensor unit is structured with two IR light-emitting diodes (LEDs) as light sources and one IR Photo sensor to detect a movement of one dimension. It's broadly utilized, not just for a handheld device, but also for security equipment, like an intruder sensor or so. However, the proximity sensor unit is merely available for the proximity sensing and can determine one dimension movement of the human hand only.

### SUMMARY OF THE INVENTION

Embodiments of the present invention provide an input device, a user equipment and a method for determining a movement, which can determine 2D or 3d dimension movement of an object moving over the input device.

In a first aspect, there is provided an input device, including: an AMFPD module, which comprises an AMFPD substrate; a light source, assembled on the AMFPD module; a plurality of sensors, embedded in the AMFPD substrate, wherein each of the plurality of sensors is configured to detect a light ray of the light source reflected by an object over the AMFPD substrate and output a signal which is transformed from the light ray; a controller, connected to the plurality of sensors and configured to receive signals output from the plurality of sensors and determine a movement of the object according to signals output from the plurality of sensors.

In a first possible implementation form of the input device according to the first aspect, the plurality of sensors comprises four sensors which are arranged on four edges of the AMFPD substrate, respectively.

In a second possible implementation form of the input device according to the first aspect or first possible implementation form, the sensors are photo sensors.

In a third possible implementation form of the method according to the second possible implementation form, the light source comprises an Infra-Red Light Emitting Diode IR LED, and each of the plurality of sensors comprises an IR photo sensor.

In a fourth possible implementation form of the method according to the first aspect or according to the any of the preceding implementation forms of the first aspect, the controller is configured to determine a movement of two dimensions or three dimensions of the object according to intensities of signals output from the plurality of sensors.

In a second aspect, there is provided a user equipment which includes the input device according to any of the preceding implementation forms of the first aspect.

In a third aspect, there is provided a method for determining a movement, including: receiving signals output from a plurality of sensors embedded in an AMFPD substrate in a the AMFPD module of an input device, wherein each of the plurality of sensors is configured to detect a light ray of a light source reflected by an object over the AMFPD substrate and output a signal which is transformed from the light ray, wherein the light source is assembled on the AMFPD module; determining a movement of the object according to signals output from the plurality of sensors.

In a first possible implementation form of the method according to the third aspect, the plurality of sensors comprises four sensors which are arranged on four edges of the AMFPD substrate, respectively.

In a second possible implementation form of the method according to the third aspect or first possible implementation form, the sensors are photo sensors.

In a third possible implementation form of the method according to the third aspect or according to the any of the preceding implementation forms of the third aspect, the determining a movement of the object according to signals output from the plurality of sensors includes: determining a movement of two dimensions or three dimensions of the object according to intensities of signals output from the plurality of sensors and a relationship between intensities of signals and distances.

According to embodiments of the present invention, the plurality of sensors embedded in an AMFPD substrate of an input device are employed to detect a light ray of a light source assembled on an AMFPD module which includes the AMFPD substrate reflected by the object over input device, and a 2D or 3D movement of the object is determined according to signals output from the plurality of sensors. Since the outputs of plurality of sensors can reflect the movement of the object in a 2D or 3D dimension space, the 2D or 3d movement can be determined.

### BRIEF DESCRIPTION OF THE DRAWINGS

To illustrate the technical solutions in the embodiments of the present invention more clearly, a brief introduction on the accompanying drawings which are needed in the description of the embodiments or the prior art is given below. Apparently, the accompanying drawings in the description below are merely some of the embodiments of the present invention, based on which other drawings can be acquired by the persons of ordinary skill in the art without any inventive effort.

FIG. 1 is a block diagram illustrating major components of an input device according to an embodiment of the present invention.

FIG. 2 is a schematic distribution of a plurality of photo sensors on a substrate of an input device according to another embodiment of the present invention.

FIG. 3 is a sectional view of an input device according to an embodiment of the present invention.

FIG. 4 is a schematic graph of the time and the outputs of photo sensors according to embodiments of the present invention.

FIG. 5 is a circuit diagram of an AMFPD substrate.

FIG. 6 is a sectional view of a TFT in an AMFPD substrate of FIG. 5.

FIG. 7 is a sectional view of photo sensor according to another embodiment of the present invention.

FIG. 8 illustrates a schematic flow chart of a method for determining a movement according to an embodiment of the present invention.

### EMBODIMENTS OF THE INVENTION

The technical solutions in the embodiments of the present invention will be described clearly and completely hereinafter with reference to the accompanying drawings in the embodiments of the present invention. Evidently, the described embodiments are merely part, but not all, of the embodiments of the present invention. All other embodiments, which can be derived by persons of ordinary skills in the art based on the embodiments of the present invention without any inventive efforts, shall fall into the protection scope of the present invention.

It shall be understood by those skilled in the art that the techniques disclosed herein are applicable to various electronic devices, such as a mobile phone, a smart phone, a phablet, a tablet, a personal assistant, etc.

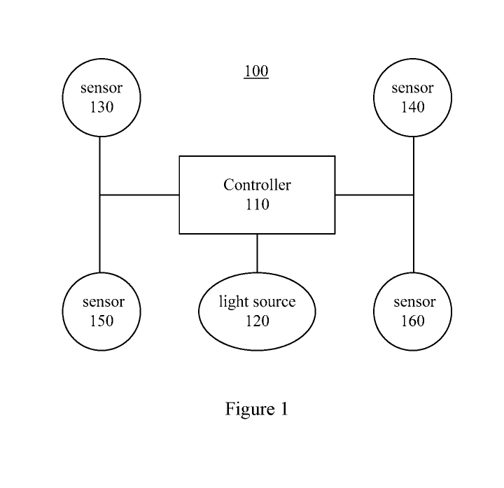

FIG. 1 is a block diagram illustrating major components of an input device 100 according to an embodiment of the present invention.

Referring to FIG. 1, the input device 100 includes an AMFPD module which includes an AMFPD substrate (not shown); a light source 120, assembled on the AMFPD module; a plurality of sensors 130, 140, 150 and 160, embedded in the AMFPD substrate, wherein each of the plurality of sensors 130, 140, 150 and 160 is configured to detect a light ray of the light source 120 reflected by an object over the sensor and output a signal which is transformed from the light ray; and a controller 110, connected to the plurality of sensors 130, 140, 150 and 160 and receive signals output from the plurality of sensors and configured to determine a movement or gesture of the object according to the signals output from the plurality of sensors 130, 140, 150 and 160.

Specifically, when an object (for example, a human hand) moves over the input device, the light rays emitted from the light source of the input device may be reflected by the object and enter into at least two photo sensors in the plurality of sensors. The at least two photo sensors may convert or transform the light rays into signals and output the signals to the controller. The controller may determine the movement of the object in the two dimension space or three dimension space according to signals output from the plurality of sensors.

According to embodiments of the present invention, the plurality of sensors embedded in a substrate of an input device are employed to detect a light ray of a light source assembled on a display module which includes the substrate reflected by the object over input device and a movement or gesture of the object is determined according to signals output from the plurality of photo sensors. Since the outputs of plurality of photo sensors can sense the movement or gesture of the object in a 2D or 3D dimension space, the 2D or 3d movement can be determined.

Those skilled in the art shall understand that the number of the photo sensors may be more than two, for example, three, four or more.

According to embodiments of the present invention, the sensors are photo sensors.

According to embodiments of the present invention, the plurality of photo sensors 130, 140, 150 and 160 includes four photo sensors which are arranged on four edges of the substrate, respectively.

For example, each photo sensor is arranged in the center of one edge of the substrate, and the embodiments of the present invention are not limited thereto, for example, each photo sensor may be arranged at a corner of the substrate or uniformly arranged on other movement of the substrate as requested. For example, the controller may receive the signals output from at least three photo sensors in the four photo sensors, and calculates the movement of the object according to the intensities of the signals.

For example, The AMFPD substrate is generally made with a specific substrate (like glass, etc.) in which a display driving circuit is embedded. The substrate may be other transparent substrate, for example, transparent ceramics substrate, etc. The display driving circuit includes electronic components such as a transistor/diode and other passive components for driving the display. According to the embodiments of the present invention, the plurality of photo sensors are embedded additionally in such AMFPD substrate and can be driven by electronic components such as a transistor/diode and other passive components for driving the display. The AMFPD module is generally made with the AMFPD substrate, other discrete components of light source for visible light wavelength, driving electronics, and mechanical components (like chassis, etc.). According to the embodiments of the present invention, the light source for determining the movement of the object is assembled additionally on the AMFPD module. In this case, the photo sensors which are embedded in the AMFPD substrate and the light source which is assembled on the AMFPD module may be employed to determine the movement of the object over the input device without any remarkable drawback of an additional physical space which is required for additional discrete components of a conventional proximity sensor unit.

Specifically, the input device is structured with multiple photo sensors (for example more than two photo sensors), embedded in the AMFPD substrate, and light source (for example, LED) assembled on the AMFPD module, for the detection of the object (for example, human hand). The object over the input device reflects light rays emitted from the light source into photo sensors at different edges of the AMFPD, and the movement of object can be determined by the different intensity of sense at each photo sensor.

According to embodiments of the present invention, the light source comprises an IR LED. For example, the IR LED may be a backlight source which is assembled on the AMFPD module. Alternatively, the light source may be a dedicated IR LED which is assembled on the AMFPD module to generate the light ray for sensing the movement of the objection.

According to embodiments of the present invention, each of the plurality of photo sensors comprises an IR photo sensor. For example, the IR photo sensor may be a photo transistor which is embedded in the AMFPD substrate.

According to embodiments of the present invention, the controller is configured to determine a movement of two dimensions or three dimensions of the object according to intensities of signals output from the plurality of photo sensors and a relationship between intensities of signals and distances.

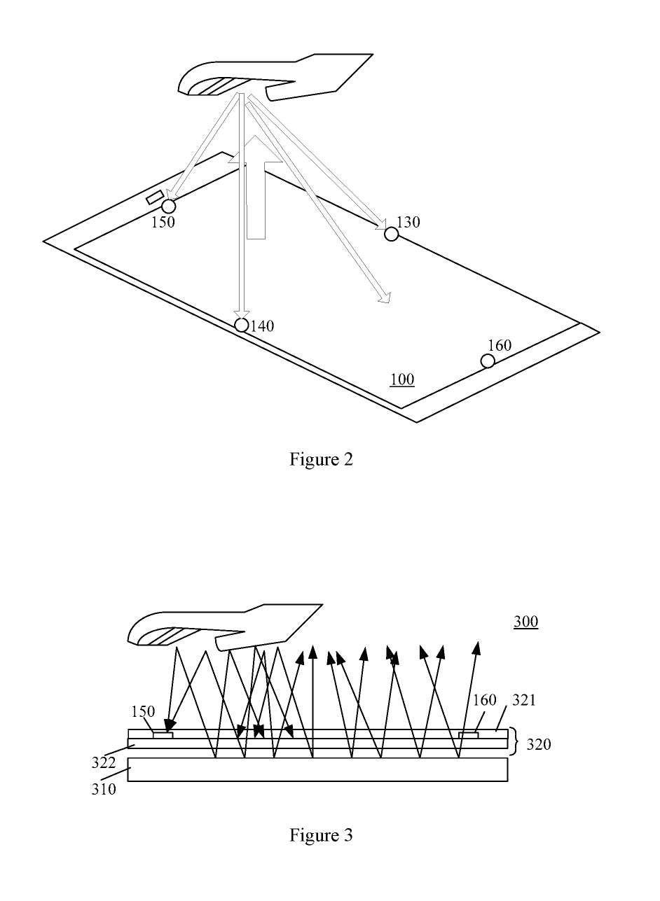

FIG. 2 is a schematic distribution of a plurality of photo sensors on a substrate of an input device according to another embodiment of the present invention.

Referring to FIG. 2, four photo sensors 130, 140, 150 and 160 are arranged on four edges of the substrate of input device 100, respectively. For example, photo sensor 130 is embedded on the center of left edge of the substrate, photo sensor 140 is embedded on the center of the right edge of the substrate, photo sensor 150 is embedded on the center of the top edge of the substrate, and photo sensor 160 is embedded on center of the bottom edge of the substrate. When a human hand moves over input device 100, the light ray emitted from the light resource may be reflected by the human hand closing the substrate. When the reflected light rays enter a photo sensor, the photo sensor converts the incident light ray into a signal which indicates the intensity of the incident light ray, and outputs the signal to the controller.

A conventional proximity sensor unit is only able to sense one dimension movement of the hand (for example, from right to left) in space when it is structured with a photo sensor and two light sources. For example, the conventional proximity sensor unit is only able to sense a movement in x-axial or y-axial. In order to implement sensing of 2D/3D movement of the hand, the conventional proximity sensor unit requires multiple light sources (for example, more than 3) and should be placed with the distance each other, which needs a considerable physical area to mount it on electrical products. However, there is usually no enough physical space on a handheld device (for example, a smart phone). To solve the above technical problem, the input device according to the present invention provides an input device for detecting gesture and proximity, which may be structured with multiple photo sensors embedded on an Active Matrix Flat Panel Display (AMFPD) substrate and a single light source assembled on an AMFPD module which includes the AMFPD substrate, for example, The AMFPD may be an Active Matrix Liquid Cristal Display (AMLCD) or an Active-matrix organic light emitting diode (AMOLED), etc. The AMFPD substrate contains active electrical devices such as Thin Film Transistor/Thin Film Diode (TFT/TFD) and passive devices such as capacitor and resistor, which may be made by thin film layers and may be designed to be patterns on the AMFPD substrate. Those are used for switching to each of display pixel and also for driving circuit to whole of display area at the AMFPD module.

A handheld electrical device, like a telecommunication application is usually has such an AMFPD module. According to the embodiments of the present invention, for the purpose of sensing a 2D/3D gesture, no need for additional physical space to mount the above discrete components of the input device, since the discrete components are already embedded in the AMFPD.

According to the embodiments of the present invention, in addition to proximity of a hand, 2D/3D movement of the hand (i.e., a human gesture) can be also sensed by using the photo sensors and a light source which are already mounted on the substrate of the input device, thus saving the physical pace for mounting the additional light resource.

FIG. 3 is a sectional view of an input device 300 according to an embodiment of the present invention. Input device 300 includes an AMFPD module 320 made with an AMFPD substrate 321 as well as components 322 including discrete components of light source for visible light wavelength, driving electronics, and mechanical components (like chassis, etc.). For example, the components 322 may include color filters, a Liquid crystal layer, a polarizer and TFTs for the liquid crystal layer, etc. Referring to FIG. 3, light source 310 is assembled on the AMFPD module 320, and top photo sensor 150 and bottom photo sensor 160 are embedded in the AMFPD substrate 321.

Referring to FIG. 3, when the hand moves over the upper part of the substrate, the hand reflects the light rays emitted from the light source into top photo sensor 150, but no light ray is reflected into bottom photo sensor 160 since the object is close to top photo sensor 150 and far away from bottom photo sensor 160. In addition, the light rays reflected by the hand may be also detected by the left photo sensor and the right photo sensor (not shown) since they are also close to the hand and can receive the light rays reflected by the hand simultaneously.

For convenience and simplicity of description, the components 322 are arranged on the surface of the AMFPD substrate, but the embodiments of the present invention are not limited thereto, for example, the components 322 may be embedded or printed into the AMFPD substrate.

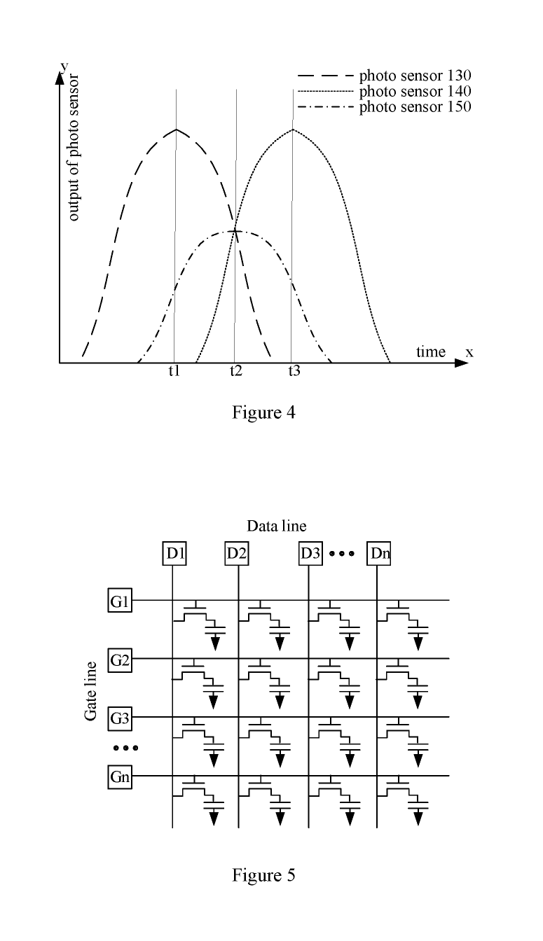

FIG. 4 is a schematic graph of the time and the outputs of photo sensors according to another embodiment of the present invention. In this embodiment, the sensor is described by taking a photo sensor as an example.

Referring to FIG. 4, y-axis represents the intensity of output signals of photo sensors, and x-axis represents the time when the hand moves from the left to the right over the upper part of the substrate of the input device. In this case, photo sensors 130, 140 and 150 may receive the reflected light rays, and photo sensor 160 receives no reflected light ray. The controller may determine the two dimension movement or three dimension movement of the hand and its movement when the hand moves over the substrate. For example, the graph in FIG. 4 illustrates that the hand moves from the left to the right over the substrate. At time t1, the distance between the hand and photo sensor 140 is farther than the distance between the hand and the photo sensor 130, at time t2, the distances between the hand and photo sensor 130, photo sensor 140 and photo sensor 150 are the same, and at time t3, the distance between the hand and the photo sensor 140 is farther than the distance between the hand and the photo sensor 130. An algorithm may be designed to calculate the movement of the hand in 2D space or 3D space in different time when the hand moves over the substrate according to the intensity of the signals outputted from the photo sensors. For example, a corresponding relationship between the intensity of signals and the distances may be preset, and the distances between the hand and photo sensor 130, photo sensor 140 may be determined according to the corresponding relationship and the signals outputted from the photo sensors. The embodiments of the present invention are not limited thereto, and other algorithms for calculating the movement of the hand in 2D space or 3D space in different time according to the intensity of the signals outputted from the photo sensors may be adopted.

FIG. 5 is a circuit diagram of an AMFPD substrate.

The AMFPD substrate includes pixel matrixes which are connected to the controller through Gate lines G1, G2, G3, . . . , Gn and data lines D1, D2, D3, . . . , Dn. Gate lines G1, G2, G3, . . . , Gn are used for selecting pixels of corresponding lines, and data lines D1, D2, D3, . . . , Dn are used for selecting pixels of corresponding columns. Each pixel may include a TFT/TFD, a liquid crystal and passive devices, for example, capacitor, resistor, etc.

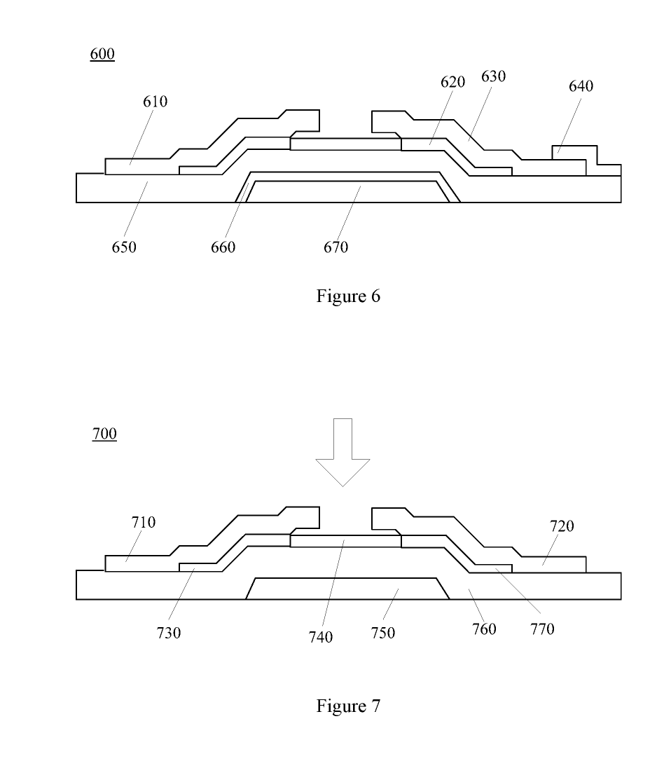

FIG. 6 is a sectional view of a TFT 600 in an AMFPD substrate of FIG. 5.

The TFT 600 may include source electrode 610, semiconductor 620, drain electrode 630, pixel electrode 640, gate insulator 650, gate electrode 660 and gate electrode 670. For example, the semiconductor 620 may be amorphous silicon or other semiconductor materials.

FIG. 7 is a sectional view of photo sensor 700 according to another embodiment of the present invention.

The photo sensor 700 may be a photo transistor. The photo transistor may include cathode electrode 710, anode electrode 720, p-type semiconductor 730, i-type semiconductor 740, gate electrode 750, gate insulator 760 and i-type semiconductor 770. The photo sensor 700 may convert the received light ray into an electrical signal.

According to the embodiments of the present invention, a user equipment is provided. The user equipment includes an input device according to any of the above embodiments of the present invention. For example, the user equipment may be a mobile phone, a smart phone, a phablet, a tablet, a personal assistant or the like.

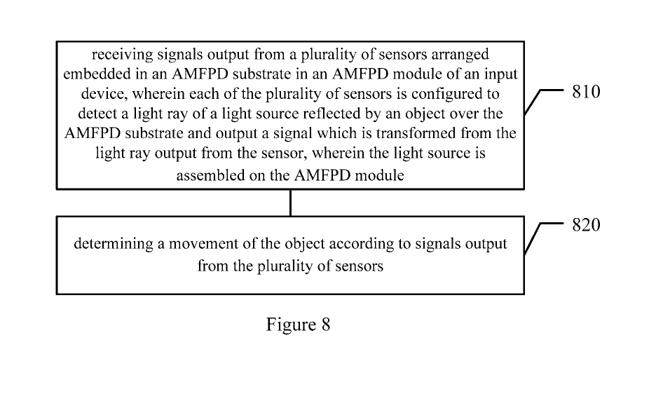

FIG. 8 illustrates a schematic flow chart of a method for determining a movement according to an embodiment of the present invention. The method is performed by a controller in an input device. The method of FIG. 8 includes the following contents.

810, receiving signals output from a plurality of sensors arranged embedded in an AMFPD substrate in an AMFPD module of an input device, wherein each of the plurality of sensors is configured to detect a light ray of a light source reflected by an object over the AMFPD substrate and output a signal which is transformed from the light ray output from the sensor, wherein the light source is assembled on the AMFPD module;

820, determining a movement of the object according to signals output from the plurality of sensors.

According to embodiments of the present invention, the plurality of sensors embedded in an AMFPD substrate of an input device are employed to detect a light ray of a light source assembled on an AMFPD module which includes the AMFPD substrate reflected by the object over input device and a movement of the object is determined according to signals output from the plurality of photo sensors.

According to embodiments of the present invention, the plurality of sensors comprises four sensors which are arranged on four edges of the substrate, respectively.

According to embodiments of the present invention, the sensors are photo sensors.

According to embodiments of the present invention, in 820, the movement of two dimensions or three dimensions of the object is determined according to intensities of signals output from the plurality of photo sensors.

The persons of ordinary skills in the art may realize that the units and steps of algorithm of the respective examples, described with reference to the embodiments disclosed in the text, can be accomplished by electronic hardware, or a combination of computer software and electronic hardware. Whether these functions are executed by means of hardware or software depends on a specific application and a design constraint condition of the technical solutions. Professional technical personnel may accomplish the described functions by adopting a different method for each specific application, but this kind of accomplishment shall not go beyond the scope of the present invention.

Those skilled in the art may understand clearly that, for convenience and simplicity of description, specific working processes of the above-described systems, apparatus and units may be referred to corresponding processes in the aforementioned embodiments of the methods, and will not be described repeatedly herein.

In several embodiments provided by the present application, it shall be understood that disclosed systems, apparatus and methods may be implemented by other manners. For example, the embodiments of the apparatus described above are just illustrative. For example, division of the units is just a kind of division according to logical functions, and there may be other division manners for practical implementations. For example, a plurality of units or components may be combined or integrated into another system, or some features may be neglected or may not be performed. In addition, the shown or discussed mutual coupling or direct coupling or communication link may be an indirect coupling or communication link through some interfaces, apparatus or units, which may be in an electrical form, a mechanical form or in other forms.

The units described as separated parts may be, or may not be, physically separated, and the parts shown as units may be, or may not be, physical units, which may be located in one place or distributed to a plurality of network elements. Part or all units therein may be selected, according to an actual need, to implement the objective of solutions provided in the present invention.

In addition, the respective functional units in the respective embodiments of the present invention may be integrated into one processing unit, or the respective units may exist separately and physically, or, two or more units may be integrated into one unit.

If the function is implemented in the form of a software functional unit and is sold or used as an independent product, the function may be stored in a computer readable storage medium. Based on this understanding, the spirit, or the parts that make contributions to the prior art, of the technical solution in the present invention may be embodied in the form of a software product. The computer software product is stored in a storage medium, and includes a number of instructions that enable a computer device (may be a personal computer, a server, or a network device) to execute all or part of steps of the method described in the respective embodiments of the present invention. The preceding storage mediums includes various mediums that can store program codes, such as, a U disk, a removable hard disk, a read-only memory (Read-Only Memory, ROM), a random access memory (Random Access Memory, RAM), a magnetic disk, an optical disk, or the like.

The foregoing descriptions are merely specific embodiments of the invention, rather than limiting the protection scope of the invention. It is easy for any one skilled in the art to conceive changes or substitutions within the technical scope disclosed by the invention, and the changes or substitutions shall fall in the protection scope of the invention. Therefore, the protection scope of the present invention shall be defined by the claims.

What is claimed is:

1. An input device, comprising:
an Active Matrix Flat panel Display AMFPD module, which comprises an AMFPD substrate;
a light source, assembled on the AMFPD module;
a plurality of sensors, embedded in the AMFPD substrate, wherein each of the plurality of sensors is configured to detect a light ray of the light source reflected by an object over the AMFPD substrate and output a signal which is transformed from the light ray;
a controller, connected to the plurality of sensors and configured to receive signals output from the plurality of sensors and determine a movement of the object according to the signals output from the plurality of sensors.

2. The input device according to claim 1, wherein the plurality of sensors comprises four sensors which are arranged on four edges of the AMFPD substrate, respectively.

3. The input device according to claim 1 or 2, wherein the sensors are photo sensors.

4. The input device according to claim 3, wherein the light source comprises an Infra-Red Light Emitting Diode IR LED, and each of the plurality of photo sensors comprises an IR photo sensor.

5. The input device according to any of claims 1 to 4, wherein the controller is configured to determine a movement of two dimensions or three dimensions of the object according to intensities of signals output from the plurality of sensors.

6. A user equipment, comprising: the input device according to any of claims 1 to 5.

7. A method for determining a movement, comprising:
receiving signals output from a plurality of sensors embedded in an Active Matrix Flat panel Display AMFPD substrate in an AMFPD module of an input device, wherein each of the plurality of sensors is configured to detect a light ray of a light source reflected by an object over the AMFPD substrate and output a signal which is transformed from the light ray, wherein the light source is assembled on the AMFPD module;
determining a movement of the object according to signals output from the plurality of sensors.

8. The method according to claim 7, wherein the plurality of sensors comprises four sensors which are arranged on four edges of the AMFPD substrate, respectively.

9. The method according to claim 7 or 8, wherein the sensors are photo sensors.

10. The method according to any of claims 7 to 9, wherein the determining a movement of the object according to signals output from the plurality of photo sensors, comprising:
determining a movement of two dimensions or three dimensions of the object according to intensities of signals output from the plurality of photo sensors.
